(19) United States
(12) Patent Application Publication
(10) Pub. No.: US 2011/0076545 A1
(43) Pub. Date: Mar. 31, 2011

(54) STACK TYPE BATTERY AND BATTERY MODULE

(75) Inventors: Yoshitaka Shinyashiki, Kobe-shi (JP); Hitoshi Maeda, Kobe-shi (JP); Yoshito Kaga, Kobe-shi (JP); Atsuhiro Funahashi, Osaka (JP); Masayuki Fujiwara, Kasai-shi (JP)

(73) Assignee: SANYO ELECTRIC CO., LTD., Osaka (JP)

(21) Appl. No.: 12/892,174

(22) Filed: Sep. 28, 2010

(30) Foreign Application Priority Data
Sep. 28, 2009 (JP) 2009-222952

(51) Int. Cl. H01M 2/14; H01M 6/42

(52) U.S. Cl. 429/144; 429/158

(57) ABSTRACT

A plurality of positive electrode plates (1) and a plurality of negative electrode plates are alternately stacked with separators interposed between the positive and negative electrodes. Positive electrode leads (11) and negative electrode leads extending outward from the respective electrode plates are respectively stacked on and joined to a positive electrode current collector terminal and a negative electrode current collector terminal to form a stack type battery. An incision (35) is formed in the positive electrode lead (11) so that a current (C11) passing through the lead (11) is branched into a plurality (two) of paths (D1, D2) by the incision (35), and the maximum current density of one (D1) of the plurality of paths (D1, D2) is equal to or greater 1.5 times of the maximum current density of the other path (D2).

### BACKGROUND OF THE INVENTION

1. Field of the Invention

The present invention relates to stack type batteries, and more particularly to stack type batteries used for, for example, robots, electric vehicles, and backup power sources that have high capacity and high-rate capability.

In particular, the invention relates to a lithium-ion battery that offers light weight and good safety, that has excellent high-rate capability, and that requires high reliability.

The invention also relates to a battery module comprising a plurality of batteries, and more particularly to a battery module that is lightweight and safe, that has excellent high-rate capability, and that is highly reliable.

2. Description of Related Art

In recent years, batteries have been used for not only the power source of mobile information terminal devices such as mobile-phones, notebook computers, and PDAs but also for such applications as robots, electric vehicles, and backup power sources. This has led to a demand for higher capacity batteries. Because of their high energy density and high capacity, lithium-ion batteries are widely used as the power sources for such applications as described above.

The battery configurations of the lithium-ion batteries are broadly grouped into two types: a spirally-wound type lithium-ion battery, in which a spirally wound electrode assembly is enclosed in a battery case, and a stack type lithium-ion battery (stack-type prismatic lithium ion battery), in which a stacked electrode assembly comprising a plurality of stacks of rectangular-shaped electrodes is enclosed in a battery case or a laminate battery case prepared by welding laminate films together.

Of the above-described lithium ion secondary batteries, the stack type lithium-ion battery in which a stacked electrode assembly is enclosed in a laminate battery case has the following structure of the stacked electrode assembly. A required number of sheet-shaped positive electrode plates each having a positive electrode current collector lead and a required number of sheet-shaped negative electrode plates each having a negative electrode current collector lead are stacked with separators interposed between the positive and negative electrode plates.

As described above, the lithium-ion battery has high capacity and high power. For this reason, when an internal short circuit occurs at a portion in the stacked electrodes, a large current may flow from the stacked electrodes to the portion where the short circuit has occurred. When such a large current flow occurs, problems arise that the lithium-ion battery itself can be damaged, and moreover, the lithium-ion battery itself generates heat, radiating a large amount of heat to the surroundings.

In view of that, Japanese Published Unexamined Patent Application Nos. 2005-149794 and H08-185850 propose that at least one of the electrode main body or the lead part is provided with a narrow fuse portion (resistor portion) for limiting a current path so that, when a short circuit occurs, the fuse portion melts so as to electrically isolate the portion where the short circuit has occurred, to prevent the short circuit current from concentrating locally.

In addition, according to Japanese Published Unexamined Patent Application No 2007-103218, bending of a lead is facilitated by providing a slit in the lead.

However, according to the configurations disclosed in Japanese Published Unexamined Patent Publications 2005-149794 and H08-185850, it is necessary to make the fuse portion narrow to make the cross-sectional area thereof small and to thereby increase the resistance value in order to allow the lead to melt down reliably when an abnormal current flow occurs. As a consequence, the rate performance during high-rate charge and discharge becomes poor.

On the other hand, Japanese Published Unexamined Patent Application No 2007-103218 proposes a solution to a problem in the process of winding electrode plates in a spirally-wound type (coiled type) battery. The problem is that when the portion of an electrode plate to which a lead is attached has high rigidity and does not bend easily, an edge of the lead penetrates a separator, causing a short circuit. In view of the problem, the publication proposes that a slit be provided vertically (i.e., in a current direction) in the lead so that the lead can be bent easily. Therefore, it is not intended to provide the lead with the fuse function. Actually, although the publication discloses a desirable range of the gap between adjacent slits, as shown in, for example, paragraph [0024], it does not disclose that the widths of the portions divided by the slits are varied. In this case, the vertical slits merely divide the lead into a plurality of portions, and there is no difference in the widths of the plurality of portions, so the fuse effect is not particularly great when an abnormal current flows. This means that although it may serve as a means to facilitate bending of the lead, it is not sufficient as a means to ensure the safety of the battery when abnormal current flows. Moreover, the problem that is dealt with in the publication, i.e., the difficulty in bending the portion of an electrode plate to which a lead is attached in the process of winding electrode plates, is unique to the spirally-wound type battery, which is irrelevant to the stack type battery. Thus, the disclosure of JP 2007-103218A does not suggest in any way how the battery safety of the stack type battery should be ensured in the case where an abnormal current flow occurs in the stack type battery.

Accordingly, it is an object of the present invention to provide a stack type battery that can ensure the safety of the battery without increasing the internal resistance of the battery when an abnormal current flow occurs because of internal short circuits or the like.

It is also an object of the present invention to provide a battery module that can ensure the safety of the battery without increasing the resistance of the battery when an abnormal current flow occurs because of internal short circuits or the like.

In order to accomplish the foregoing and other objects, the present invention provides a stack type battery comprising:

a plurality of positive electrode plates; a plurality of negative electrode plates; a plurality of separators interposed between the positive and negative electrode plates alternately stacked on each other; a positive electrode current collector terminal; a negative electrode current collector terminal, a plurality of positive electrode leads extending outward from the respective positive electrode plates, the positive electrode leads being stacked on each other and joined to the positive electrode current collector terminal; and a plurality of negative electrode leads extending outward from the respective negative electrode plates, the negative electrode leads being stacked on each other and joined to the negative electrode current collector terminal, wherein

at least one of the positive electrode lead and the negative electrode lead has an incision formed therein so that a current passing through the lead is branched into a plurality of paths by the incision and that the maximum current density of any of the plurality of paths is equal to or greater than 1.5 times the maximum current density of any other of the plurality of the paths.

In the above-described configuration of the present invention, a plurality of paths in which their current densities are non-uniform, including a pair of current paths in which the difference between their maximum current densities is 1.5 times or greater, are formed in the lead by the incision. When a large current flows into the lead due to the occurrence of an internal short circuit, the current passes through a portion of the lead intensively, and consequently, the lead melts down in the portion in which the current density is highest. Thereafter, the current concentrates in the portion in which the current density is the next highest, and the lead melts down also in that portion. In this way, it becomes possible to melt the lead at a low current value without reducing the cross-sectional area of the lead and increasing the resistance value, by allowing the lead to melt successively from the portion at which the current density is highest to the next one.

In addition, by merely forming an incision in the lead, the safety of the battery can be ensured easily with a simple configuration.

It is desirable that the incision be formed in a substantially hook shape, the incision having a transverse portion extending from one side edge adjacent region of the lead to the other side edge adjacent region in a direction crossing a current flowing through the lead when an internal short circuit occurs, and a longitudinal portion extending from one end of the transverse portion in substantially the opposite direction to the direction in which the current flows when the internal short circuit occurs.

In the present invention, the term “a direction crossing a current” means a direction that crosses the current direction at an angle of, for example, from about 45° to about 90°, more desirably from about 70° to about 90°. The term “substantially the opposite direction to the direction in which the current flows” means a direction at an angle of from ±160° to ±180°, more desirably ±170° to ±180°, when the current direction is 0°.

The term “a substantially hook shape” is broadly meant to include a shape in which a line, either linear or curvilinear, is bent to one side at any degree in a hooked shape, an angle bracket shape, or the like. It is also possible that at least one of the transverse portion and the longitudinal portion may extend slightly outward from the bent portion (i.e., the crossing corner portion), in other words, two lines that form the transverse portion and the longitudinal portion may intersect at one end of the transverse portion so as to form a substantially T-shape, a substantially cruciate shape, or the like.

In the above-described configuration, current paths are formed between the incision and both side edges of the lead, and the current passing through the lead flows separately through is branched into the two paths. Since the longitudinal portion is formed at one end of the transverse portion of the incision, the path on the side in which the longitudinal portion is formed extends narrower and has a higher resistance than the path in the other side, so electric current is difficult to pass therethrough. As a result, the current passing through the lead flows through the path in the other side dominantly, allowing the lead to melt down more easily in a location in the other side. This allows the lead to melt down easily and reliably.

It is desirable that the transverse portion and the longitudinal portion of the incision extend linearly so that the incision is in a substantially L-shape.

In the present invention, the term “a substantially L-shape” means a shape included in the above-mentioned “a substantially hook shape” in which a straight line is bent to one side at one point, and the angle of the bend is not limited to the right angle. In other words, the directions of the linear transverse portion and the linear longitudinal portion that form the incision in an L-shape can vary, for example, within the foregoing range.

With this configuration, the difference in the degree of how easy a current can flow into the two paths becomes greater, and therefore, the lead can be melted down more easily and reliably.

It is possible that a crossing corner portion of the transverse portion and the longitudinal portion of the incision may be formed in a curved shape.

Even when the incision has a curved portion at its crossing corner portion as described above, the lead can be melted easily and reliably as long as the transverse portion and the longitudinal portion are formed.

The present invention also provides a battery module comprising:

a plurality of batteries connected in parallel, wherein

at least one of a conductor connecting positive electrodes to each other and a conductor connecting negative electrodes to each other between the batteries has an incision formed therein so that a current passing through the conductor is branched into a plurality of paths by the incision and that the maximum current density of any of the plurality of paths is equal to or greater than 1.5 times the maximum current density of any other of the plurality of the paths.

In the battery module of the present invention, each of the terms “a conductor electrically connecting positive electrodes to each other” and “a conductor electrically connecting negative electrodes to each other” means to include any conducting part that electrically connects the positive electrodes or the negative electrodes, which serve as the power-generating elements, to each other between the unit cells (single batteries), such as the positive and negative electrodes current collector leads and the positive and negative electrode current collector terminals in the battery (unit cell or a single battery) contained in the battery module, as well as a conductor that connects the unit cells (single batteries) to each other.

The battery (unit cell or a single battery) that is contained in the battery module may include both one in which a plurality of positive electrodes and a plurality of negative electrodes are connected in parallel in each battery and one having other configurations.

In the case of the battery module comprising a plurality of batteries connected in parallel, an abnormal current flow may occur because of internal short circuits or the like as in the case of the stack type battery. To prevent this problem, an incision may be formed in at least one of the conductor electrically connecting the positive electrodes to each other and the conductor electrically connecting the negative electrodes to each other between the batteries (the unit cells) that form the battery module so that the current passing through the conductor is branched into a plurality of paths by the incision and that the maximum current density of any of the plurality of paths is equal to or greater than 1.5 times the maximum current density of any other path. In this way, it is possible to construct a mechanism with a simple configuration that can effectively cut off an abnormal current flow that occurs due to a short circuit without increasing the resistance, in a similar manner to the case of the stack type battery.

In the batter module of the present invention, it is desirable that the incision be formed in a substantially hook shape, the incision having a transverse portion extending from one side edge adjacent region of the conductor to the other side edge adjacent region in a direction crossing a current flowing through the conductor when an internal short circuit occurs, and a longitudinal portion extending from one end of the transverse portion in substantially the opposite direction to the direction in which the current flows when the internal short circuit occurs.

In the above-described configuration, current paths are formed between the incision and both side edges of the conductor, and the current passing through the conductor flows separately through is branched into the two paths. Since the longitudinal portion is formed at one end of the transverse portion of the incision, the path on the side in which the longitudinal portion is formed extends narrower and has a higher resistance than the path in the other side, so electric current is difficult pass therethrough. As a result, the current passing through the conductor flows through the path in the other side more intensely, allowing the conductor to melt down more easily in a location in the other side. This allows the conductor to melt down easily and reliably.

In the battery module of the present invention, it is desirable that the transverse portion and the longitudinal portion of the incision extend linearly so that the incision is in a substantially L-shape.

With this configuration, the difference in the degree of how easy a current can flow into the two paths becomes greater, and therefore, the conductor can be melted down more easily and reliably.

In the battery module of the present invention, it is possible that a crossing corner portion of the transverse portion and the longitudinal portion of the incision may be formed in a curved shape.

Even when the incision has a curved portion at its crossing corner portion as described above, the conductor can be melted easily and reliably as long as the transverse portion and the longitudinal portion are formed.

According to the present invention, it becomes possible to melt a lead (or a conductor) at a low current value without reducing the cross-sectional area of the lead (or the conductor) to increase the resistance value. As a result, the safety of the battery can be ensured when an abnormal current flow occurs due to an internal short circuit or the like while maintaining high-rate charge-discharge performance without increasing the internal resistance of the battery.

### BRIEF DESCRIPTION OF THE DRAWINGS

FIG. 1 shows portions of a stack type battery according to the present invention, wherein FIG. 1(a) is a plan view illustrating a positive electrode thereof, FIG. 1(b) is a perspective view illustrating a separator thereof, and FIG. 1(c) is a plan view illustrating a pouch-type separator thereof in which the positive electrode is disposed;

FIG. 2 is a plan view illustrating a negative electrode plate used for the stack type battery according to the present invention;

FIG. 3 is an enlarged view illustrating a positive electrode lead of a positive electrode plate used for the stack type battery according to the present invention;

FIG. 4 is an exploded perspective view illustrating a stacked electrode assembly used for the stack type battery according to the present invention;

FIG. 5 is a plan view illustrating the stacked electrode assembly used for the stack type battery according to the present invention;

FIG. 6 is a plan view illustrating how positive and negative electrode leads and positive and negative electrode current collector terminals are welded together;

FIG. 7 is a perspective view illustrating a stack type battery according to the present invention;

FIG. 8 is a schematic circuit diagram illustrating the principle of how the positive electrode lead of the stack type battery melts;

FIG. 9(a) and FIG. 9(b) are conceptual views schematically illustrating the current paths in the positive electrode lead of the stack type battery;

FIG. 10(a)-FIG. 10(e) show plan views illustrating test pieces used in a current applying test for aluminum foil;

FIG. 11 is a schematic plan view illustrating another example of the incision;

FIG. 12 is a perspective view illustrating a battery module according to the present invention; and

FIG. 13 is an enlarged view illustrating a positive electrode current collector terminal of a battery used for a battery module according to the present invention.

### DETAILED DESCRIPTION OF THE INVENTION

Hereinbelow, embodiments of the stack type battery according to the present invention are described in detail. It should be construed, however, that the stack type battery according to this invention is not limited to the following embodiments and examples but various changes and modifications are possible without departing from the scope of the invention.

### Preparation of Positive Electrode

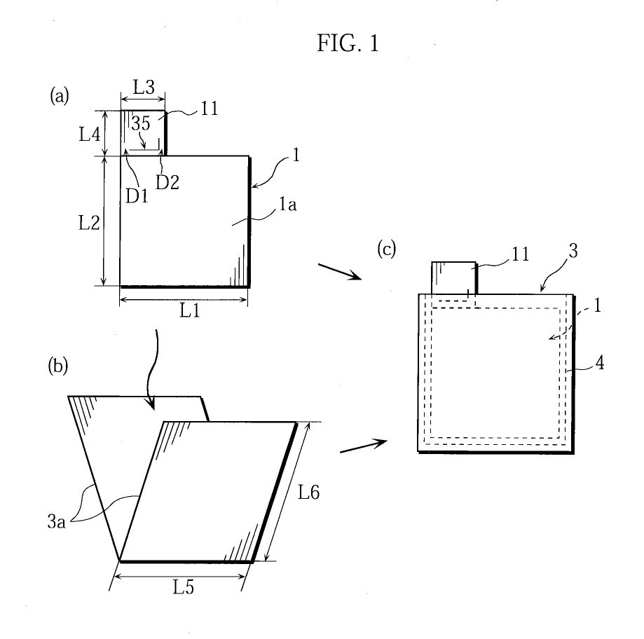

90 mass % of LiCoO₂ as a positive electrode active material, 5 mass % of carbon black as a conductive agent, and 5 mass % of polyvinylidene fluoride as a binder agent were mixed with a N-methyl-2-pyrrolidone (NMP) solution as a solvent to prepare a positive electrode mixture slurry. Thereafter, the resultant positive electrode mixture slurry was applied onto both sides of an aluminum foil (thickness: 15 μm) serving as a positive electrode current collector. Then, the material was dried to remove the solvent and compressed with rollers to a thickness of 0.1 mm. Thereafter, as illustrated in FIG. 1(a), it was cut so that a width L1=95 mm and a height L2=95 mm, to prepare a positive electrode plate 1 having a positive electrode active material layer 1a on each side. Here, a positive electrode lead 11 was formed by allowing an active material uncoated portion having a width L3=30 mm and a height L4=20 mm to extend outward from one end (the left end in FIG. 1(a)) of one side of the positive electrode plate 1 that extends widthwise.

Preparation of Pouch-Type Separator in which the Positive Electrode Plate is Disposed

The positive electrode plate 1 was disposed between two square-shaped polypropylene (PP) separators 3a (width L5=100 mm, height L6=100 mm, and thickness 30 μm) as illustrated in FIG. 1(b). Thereafter, as illustrated in FIG. 1(c), the peripheral portions of the separators 3a were thermally sealed at a sealing part 4, to prepare a pouch-type separator 3, in which the positive electrode plate 1 is accommodated.

### Preparation of Negative Electrode

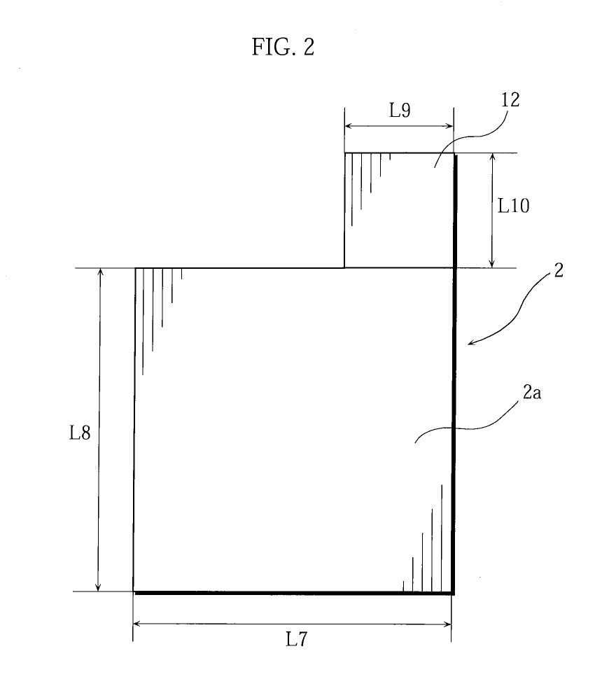

95 mass % of graphite powder as a negative electrode active material and 5 mass % of polyvinylidene fluoride as a binder agent were mixed with an NMP solution as a solvent to prepare a negative electrode slurry. Thereafter, the resultant negative electrode slurry was applied onto both sides of a copper foil (thickness: 10 μm) serving as a negative electrode current collector. Then, the material was dried to remove the solvent and compressed with rollers to a thickness of 0.08 mm. Thereafter, as illustrated in FIG. 2, it was cut so that a width L7=100 mm and a height L8=100 mm, to prepare a negative electrode plate 2 having a negative electrode active material layer 2a on each side. Here, a negative electrode lead 12 was formed by allowing an active material uncoated portion having a width L9=30 mm and a height L10=20 mm to extend outward from one end (the right end in FIG. 1(a)) of the negative electrode plate 2 that is opposite to the side end thereof at which the positive electrode lead 11 was formed, in one side of the negative electrode plate 2 that extends widthwise.

### Formation of Incision

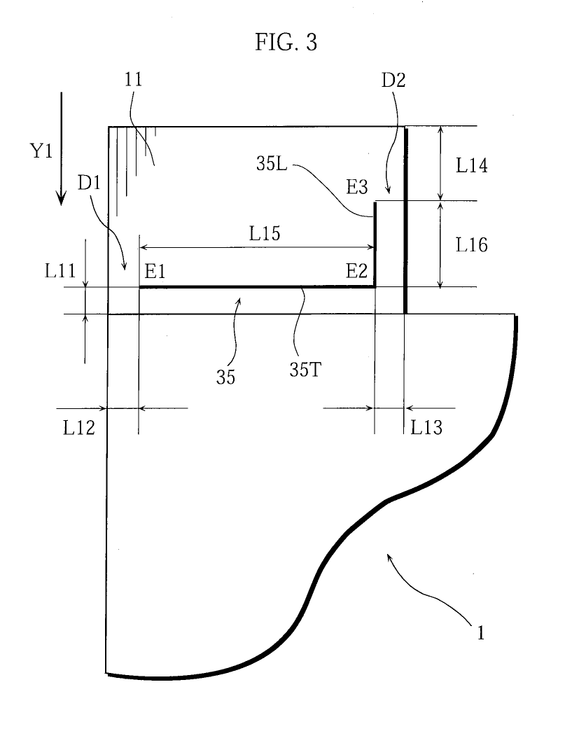

As illustrated in FIG. 1(a), an incision 35 was formed in the positive electrode lead 11 of the positive electrode plate 1. Specifically, as illustrated in FIG. 3, the incision 35 having an L-shape (a shape obtained by rotating the letter “L” 90° anticlockwise in FIG. 3) was formed in the positive electrode lead 11 so as to connect three points, a position E1, a position E2, and a position E3. The position E1 was located at a distance L11=4 mm from the edge of the positive electrode lead 11 on the positive electrode plate 1 side and at a distance L12=5 mm from the outer side edge of the positive electrode lead 11 (i.e., the side edge thereof extending along one end of the positive electrode plate 1 extending in a height direction, the left side edge in FIG. 3). The position E2 was located at the distance L11=4 mm from the edge of the positive electrode lead 11 on the positive electrode plate 1 side and at a distance L13=5 mm from the inner edge (the right side edge in FIG. 3) of the positive electrode lead 11. The position E3 was located at a distance L14=8 mm from the side edge of the positive electrode lead 11 that is the farmost from the positive electrode plate 1 (the upper side edge in FIG. 3) and at the distance L13=5 mm from the inner edge (the right side edge in FIG. 3) of the positive electrode lead 11. In the incision 35, a transverse portion 35T, which extends from the position E1 to the position E2, has a length L15 of 20 mm, and a longitudinal portion 35L, which extends from the position E2 and the position E3, has a length L16 of 8 mm.

### Preparation of Stacked Electrode Assembly

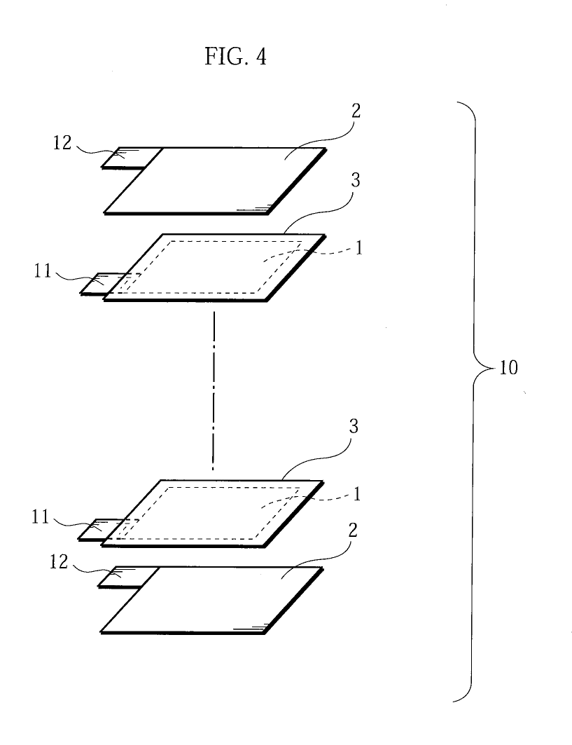

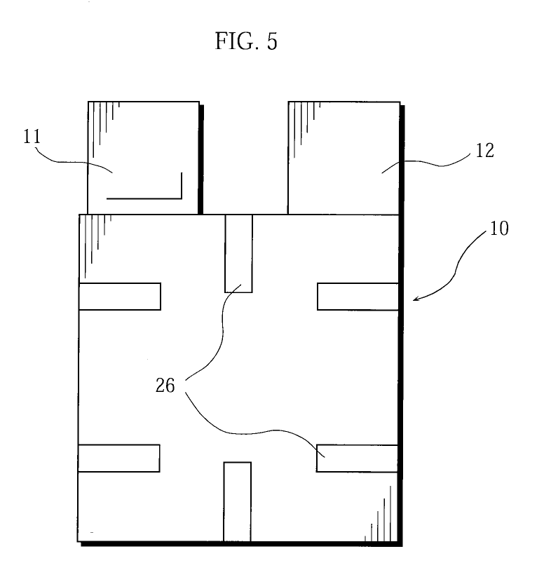

50 sheets of the pouch-type separators 3 in each of which the positive electrode plate 1 was disposed and 51 sheets of the negative electrode plates 2 were prepared, and the pouch-type separators 3 and the negative electrode plates 2 were alternately stacked one on the other, as illustrated in FIG. 4. Both top and bottom faces of the stack were the negative electrode plates 2. Subsequently, as illustrated in FIG. 5, the top and bottom faces of the stack were connected by insulating tapes 26 for retaining its shape. Thus, a stacked electrode assembly 10 was obtained.

### Welding of Current Collector Terminals

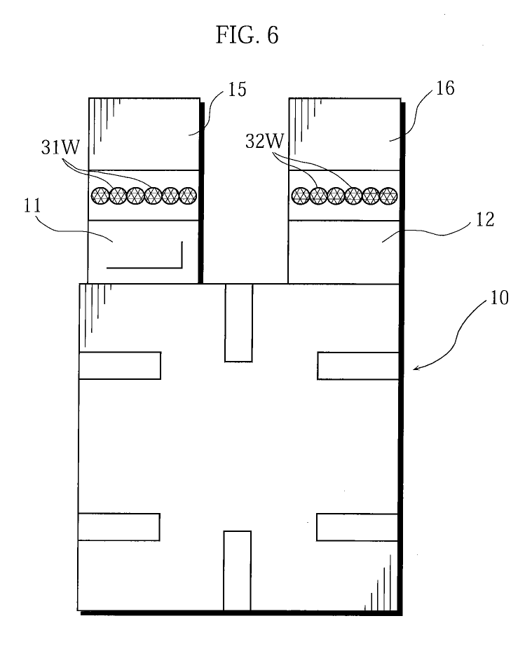

As illustrated in FIG. 6, a positive electrode current collector terminal 15 made of an aluminum plate having a thickness of 0.5 mm and a negative electrode current collector terminal 16 made of a copper plate having a thickness of 0.5 mm were joined to the respective end portions of the stacked positive electrode leads 11 and the stacked negative electrode leads 12 at weld points 31W and 32W by ultrasonic welding.

### Placing the Electrode Assembly in Battery Case

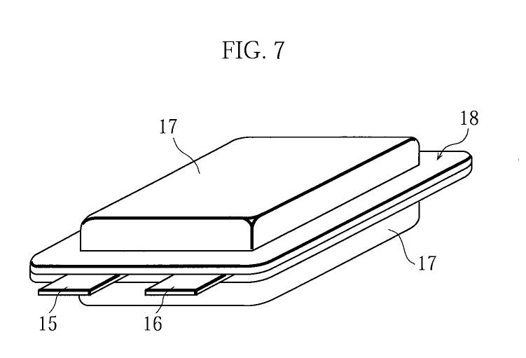

As illustrated in FIG. 7, the stacked electrode assembly 10 was inserted into a battery case 18, which had been formed of two laminate films 17 in advance so that the stacked electrode assembly 10 could be placed therein. Then, one side of the battery case in which the positive electrode current collector terminal 15 and the negative electrode current collector terminal 16 were present was thermally bonded so that only the positive electrode current collector terminal 15 and the negative electrode current collector terminal 16 would protrude from the battery case 18, and also, two sides of the remaining three sides of the battery case were thermally bonded.

### Filling Electrolyte Solution and Sealing

An electrolyte solution was prepared by dissolving LiPF₆ at a concentration of 1 M (mol/L) in a mixed solvent of 30:70 volume ratio of ethylene carbonate (EC) and methyl ethyl carbonate (MEC). The electrolyte solution was filled into the battery case 18 from the remaining one side of the battery case that was not yet thermally bonded. Lastly, the one side that had not been thermally bonded was thermally bonded. Thus, a battery was prepared.

### <Advantageous Effects of the Present Invention Battery>

1. The battery described in the foregoing embodiment (hereinafter referred to as the battery A of the invention) is a stack type battery having the following configuration. 50 sheets of the positive electrode plate 1 and 51 sheets of the negative electrode plate 2 alternately stacked on each other with the separators 3a interposed therebetween, and the positive electrode leads 11 and the negative electrode leads 12 extending outward from the respective electrode plates 1, 2 are respectively stacked on and joined to the positive electrode current collector terminal 15 and the negative electrode current collector terminal 16. As illustrated in FIG. 3, the incision 35 is formed in each the positive electrode leads 11 so that the current passing through the lead 11 is branched into a plurality (two) of paths D1, D2 by incision 35 and that the maximum current density of one of the paths D1 is equal to or greater than 1.5 times the maximum current density of the other path D2. It is clear from the results of the later-described current applying test with aluminum foils that the maximum current density of the one path D1 is equal to or greater than 1.5 times the maximum current density of the other path D2.

With the configuration of the battery A of the invention, a pair of current paths D1 and D2 in which the difference in their maximum current densities is 1.5 times or greater, i.e., a plurality (two) of paths D1 and D2 in which their current densities are non-uniform, are formed in the lead 11 by the incision 35. As a result, when a large current flows into the lead in the direction indicated by the arrow Y1 in FIG. 3 due to the occurrence of an internal short circuit, the current passes through the path D1 intensively, and consequently, the lead 11 melts down in the portion in which the current density is highest (the path D1). Thereafter, the current concentrates in the portion in which the current density is the next highest (the path D2), and the lead 11 melts down also in that portion (the path D2). In this way, it becomes possible to melt the lead 11 at a low current value without reducing the cross-sectional area of the lead 11 and increasing the resistance value, by allowing the lead 11 to melt successively from the portion at which the current density is highest (the path D11) to the next one.

In addition, the foregoing is achieved by merely forming the incision 35 in the lead 11, so the safety of the battery A of the invention is ensured easily with a simple configuration.

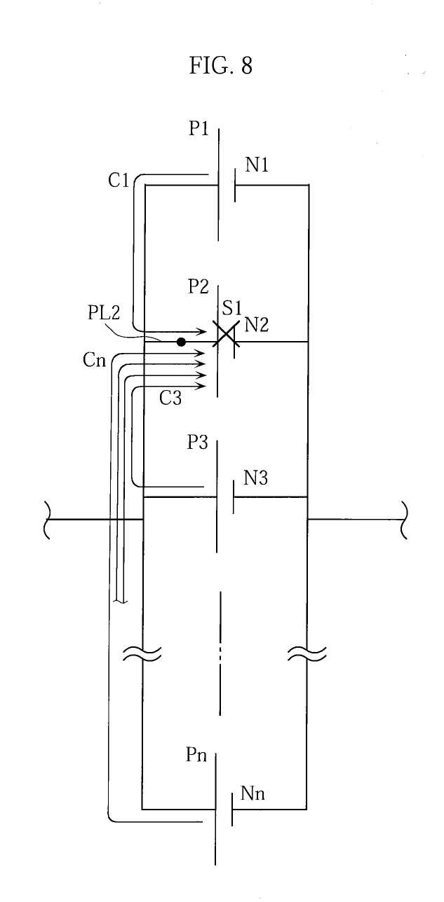

FIG. 8 is a schematic circuit diagram illustrating the principle of how the positive electrode lead melts in a stack type battery having the same configuration as the battery A of the invention. In the stack type battery shown in the figure, all of a multiplicity of positive electrode plates P1, P2, . . . , Pn are connected to each other and all of a multiplicity of negative electrode plates N1, N2, . . . , Nn are connected to each other, to form a parallel connection. Assuming that a pair of the positive electrode plate P2 and the negative electrode plate N2 causes a short circuit at the location S1 indicated by the cross in the figure, a short circuit occurs also at that location S1 between all the other positive electrode plates P1, P3, . . . , Pn and all the other negative electrode plates N1, N3, . . . , Nn, forming loop-like closed short circuits. As a consequence, currents C1, C3, . . . Cn concentrate all together from all the other positive electrode plates P1, P3, . . . , Pn, and a resulting large current passes through the short circuit location S1 (i.e., a sneak current occurs). This causes the positive electrode lead PL2 of the positive electrode plate P2, which has caused a short circuit first, to melt down (the black dot in the figure) because of the incision, cutting off the current through the short circuit location S1.

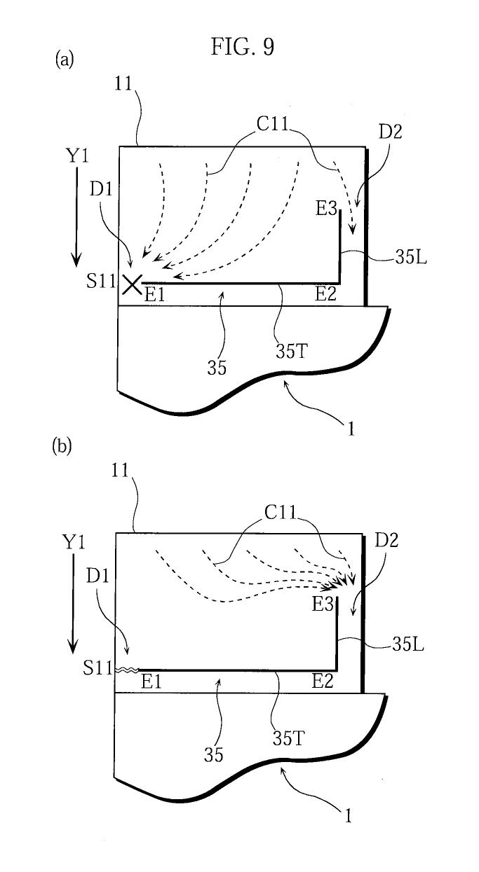

2. Moreover, the incision 35 may be formed in a substantially hook shape having the transverse portion 35T extending from one side edge (left side edge) adjacent region of the lead 11 to the other side edge (right side edge) adjacent region in a direction crossing the current passing through the lead when an internal short circuit occurs (i.e., in a width L3 direction crossing the current direction Y1 at an angle of 90° and the longitudinal portion 35L extending from one end E2 (the right end in FIG. 3) of the transverse portion 35T in the substantially opposite direction to the direction Y1 in which the current flows when an internal short circuit occurs (i.e., in a direction at an angel of 180° when the current direction Y1 is 0°, in a vertically upward direction in FIG. 3). Thus, as shown in the schematic illustrative drawing of FIG. 9, the paths D1 and D2 are formed between the incision 35 and the opposite side edges of the lead 11, and the current C11 passing through the lead 11 is branched into the two paths D1 and D2. Here, the longitudinal portion 35L is formed at one end E2 (the right end in FIG. 9) of the transverse portion 35T of the incision, and therefore, the path D2 on the side in which the longitudinal portion 35L is formed extends narrower and has a higher resistance than the path D1 in the other side, so current C11 is difficult to pass therethrough. Therefore, as illustrated in FIG. 9(a), the current C11 passing through the lead 11 flows through the path D1 in the other side dominantly, allowing the lead 11 to melt down more easily in at a portion S11 in the other side, that is, the portion S11 between the other end E1 (the left end in FIG. 9) of the transverse portion 35T of the incision 35 and one side edge (the left side edge) of the lead 11. Thereby, the lead 11 can melt down easily and reliably. As illustrated in FIG. 9(b), after the lead 11 has melted at the portion S11, the path D2 on the side in which the longitudinal portion 35L is formed remains as the only path, so the current C11 flows into the path D2 intensely, causing the lead 11 to melt at a portion in the path D2. Thus, the current C11 is cut off.

3. In addition, the transverse portion 35T and the longitudinal portion 35L of the incision 35 may be formed so as to extend linearly, and the incision 35 may be formed in an L-shape as a whole, i.e., a straight line is bent toward one side at one point E2 at the right angle. As a result, the difference in the degree of how easy the current C11 flows into the path is made greater between the paths D1 and D2. Thus, the lead 11 can melt down more easily and reliably.

Current Applying Test with Aluminum Foil

Using test pieces made of aluminum foils, the degree of how easy the aluminum foil can be melted down was determined in the following manner in order to simulate the situation in which a large current flows into the positive electrode lead or the negative electrode lead of the battery.

### Preparation of Test Pieces

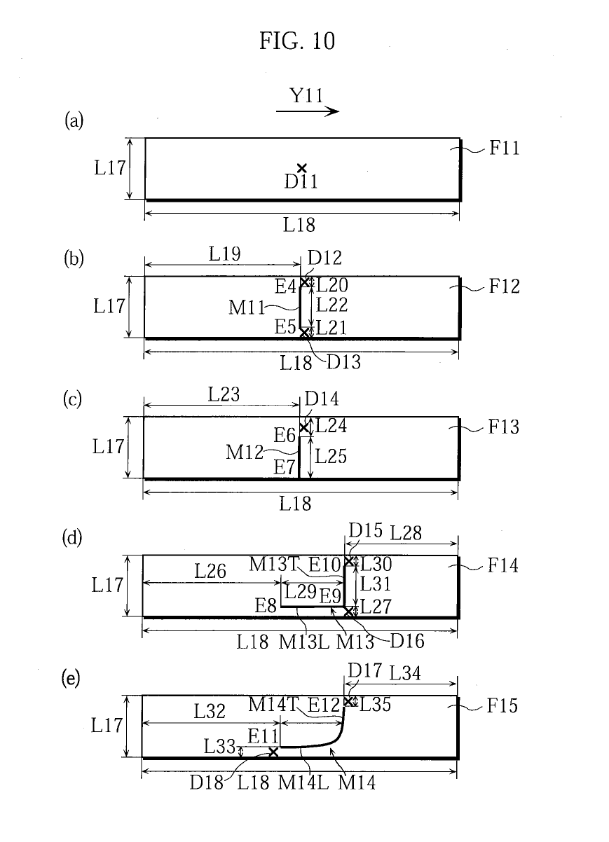

Test pieces F11 to F15 respectively made of five types of aluminum foils (thickness: 10 μm) as illustrated in FIGS. 10 (a) to 10(e) were prepared.

Test piece F11: A test piece F11 shown in FIG. 10 (a) has a strip shape (rectangular shape) with a width L17=30 mm and a length L18=150 mm. No incision was formed therein.

Test piece F12: A test piece F12 shown in FIG. 10(b) had the same strip shape (rectangular shape) as the test piece F11, with a width L17=30 mm and a length L18=150 mm. An incision M11 was formed therein so as to have a length L22=20 mm and extend from a position E4 to a position E5 linearly along the width L17 of the test piece F12. The position E4 was located at a distance L19=75 mm from one end thereof and at a distance L20=5 mm from one longer side thereof, and the position E5 was located at a distance L19=75 mm from the just-mentioned one end and at a distance L21=5 mm from the other longer side.

Test piece F13: A test piece F13 shown in FIG. 10(c) had the same strip shape (rectangular shape) as the test piece F11, with a width L17=30 mm and a length L18=150 mm. An incision M12 was formed therein so as to have a length L25=20 mm and extend from a position E6 to a position E7 linearly along the width L17 of the test piece F13. The position E6 was located at a distance L23=75 mm from one end of the test piece and at a distance L24=10 mm from one longer side thereof, and the position E7 was located on the other longer side at a distance L23=75 mm from the one end.

Test piece F14: A test piece F14 shown in FIG. 10(d) had the same strip shape (rectangular shape) as the test piece F11, with a width L17=30 mm and a length L18=150 mm. An L-shaped incision M13 having a longitudinal portion M13L and a transverse portion M13T was formed therein. The longitudinal portion M13L had a length L29=30 mm and extended from a position E8 to a position E9 linearly along the length L18 of the test piece F14. The position E8 was located at a distance L26=66.3 mm from one end and at a distance L27=5 mm from one longer side, and the position E9 was located at a distance L28=53.7 mm from the other end and at a distance L27=5 mm from the one longer side. The transverse portion M13T had a length L31=20 mm and extended from the latter position E9 in the longitudinal portion M13L to a position E10, which was located at a distance L28=53.7 mm from the other end and at a distance L30=5 mm from the other longer side, linearly along the width L17 of the test piece F14.

Test piece F15: A test piece F15 shown in FIG. 10(e) had the same strip shape (rectangular shape) as the test piece F11, with a width L17=30 mm and a length L18=150 mm. A substantially hook-shaped incision M14 was formed therein extending from a position E11 to a position E12. The position E11 was located at a distance L32=66.3 mm from one end and at a distance L33=5 mm from one longer side. The substantially hook-shaped incision M14 extends from the position E11 substantially along the length L18 of the test piece F15 so as to be slightly curved inward, to form a longitudinal portion M14L. Then, it bends so as to curve in a direction that forms an obtuse angle slightly greater than the right angle with respect to the longitudinal portion M14L. Then, it extends to the position E12 substantially along the width L17 of the test piece F15 so as to be slightly curved inward, to form a transverse portion M14T. The position E12 was located at a distance L34=53.7 mm from the other end and at a distance L35=5 mm from the other longer side. Thus, the substantially hook-shaped incision M14 is formed by a curved line as a whole and is bent in a rounded shape in its central portion, forming a substantially J-shape. In other words, a crossing corner portion of the transverse portion M14T and the longitudinal portion M14L of the incision M14 is formed in a curved shape.

### Current Applying Test

Terminals were connected to the widthwise midpoints of the opposite ends of the above-described five types of test pieces F11 to F15 so that current can flow from one end to the other end (from the left end to the right end in FIG. 10) of each of the test pieces F11 to F15, as indicated by the arrow Y11 in FIG. 10. Then, an electric current was applied to each of the above-described five types of test pieces F11 to F15 while increasing the current in steps from 40 A to 50 A and then to 80 A. In addition, the resistance value at 1 kHz was measured at the opposite ends of each of the test pieces F11 to F15. The results are shown in Table 1 below.

TABLE 1

| | Resistance | Applied current value | | |
|---|---|---|---|---|
| Test piece | (mΩ) | 40 A | 50 A | 80 A |
| F11 | 15.6 | Not melted | Not melted | Melted |
| F12 | 16.8 | Not melted | Melted | Melted |
| F13 | 16.5 | Not melted | Melted | Melted |
| F14 | 16.6 | Melted | Melted | Melted |
| F15 | 16.7 | Melted | Melted | Melted |

As shown in Table 1, the test piece F11, having a strip shape and no incision, showed the lowest resistance value, 15.6 mΩ, but it melted down at the highest current value, 80 A. The test pieces F12 to F15, in which the incisions M11 to M14 were formed therein, showed almost the same resistance values in a range of from 16.5 mΩ to 16.8 mΩ, but as for the melting current value, the test pieces F14 and F15, which had the substantially hook-shaped incisions M13 and M14, melted down at the lowest current value, 40 A. This means that when an abnormal current flow occurs, the test pieces F14 and F15 can melt down more reliably than the test pieces F12 and F13, in which their cross-sectional areas are merely narrowed by the incisions M11 and M12. Moreover, as described above, the test pieces F12 to F15, in which the respective incisions M11 to M14 were formed, showed almost the same resistance values. Therefore, the high-rate charge-discharge capability is not decreased by the test pieces F14 and F15, which respectively have the substantially hook-shaped incisions M13 and M14.

Table 2 below shows the passing current values and current densities through the following portions D11 to D18 of the test pieces F11 to F15 when a current of 40 A was applied to the test pieces F11 to F15.

D11: the center portion of the test piece F11

D12 and D13: the respective portions between the opposite ends E4, E5 of the incision M11 and the respective longer sides of the test piece F12

D14: the portion between the incision M12 and one longer side of the test piece F13

D15 and D16: the respective portions between the opposite ends E9, E10 of the transverse portion M13T of the incision M13 and the respective longer sides of the test piece F14

D17 and D18: the respective portions between the opposite ends E11, E12 of the incision M14 and the respective longer sides of the test piece F15

TABLE 2

| | | Passing current value | Width | Current density |
|---|---|---|---|---|
| Test piece | Portion | (A) | (mm) | (A/mm²) |
| F11 | D11 | 40 | 30 | 133 |
| F12 | D12 | 20 | 5 | 400 |
| | D13 | 20 | 5 | 400 |
| F13 | D14 | 40 | 10 | 400 |
| F14 | D15 | 28 | 5 | 560 |
| | D16 | 12 | 5 | 240 |
| F15 | D17 | 24 | 5 | 480 |
| | D18 | 16 | 5 | 320 |

As shown in Table 2, the test piece F11, in which no incision was formed, shows the lowest current density, 133 A/mm². In the test piece F12, current paths having the same width L20=L21=5 mm are formed in the portions D12 and D13 in the opposite sides of the incision M11, and therefore the current densities in the portions D12 and D13 are equal, 400 A/mm². In the test piece F13, the entire current 40A concentrates and flows through the current path with a width L24=10 mm in the portion D14 between the incision M12 and the one longer side, and therefore the current density is 400 A/mm².

On the other hand, in the test pieces F14 and F15, in which the substantially hook-shaped incisions M13 and M14 were formed, the current densities are higher in the portions D15, D17 in the opposite sides to the sides in which longitudinal portions M13L and M14L are formed than the portions D16 and D18 in the sides in which the longitudinal portions M13L and M14L are formed. Specifically, in the test piece F14 having the L-shaped incision M13, the current density of the portion D15, which is in the opposite side to the side in which the longitudinal portion M13L is formed, is the highest, 560 A/mm², which is about 2.3 times the current density of the portion D16 in the side in which the longitudinal portion M13L is formed, 240 A/mm². In the test piece F15 having the substantially hook-shaped incision M14, which forms a curved shape and a substantially J-shape, the current density of the portion D17, which is in the opposite side of the side in which the longitudinal portion M14L is formed, is 480 A/mm², which is about 1.5 times the current density of the portion D18 in the side in which the longitudinal portion M14L is formed, 320 A/mm².

### Other Embodiments

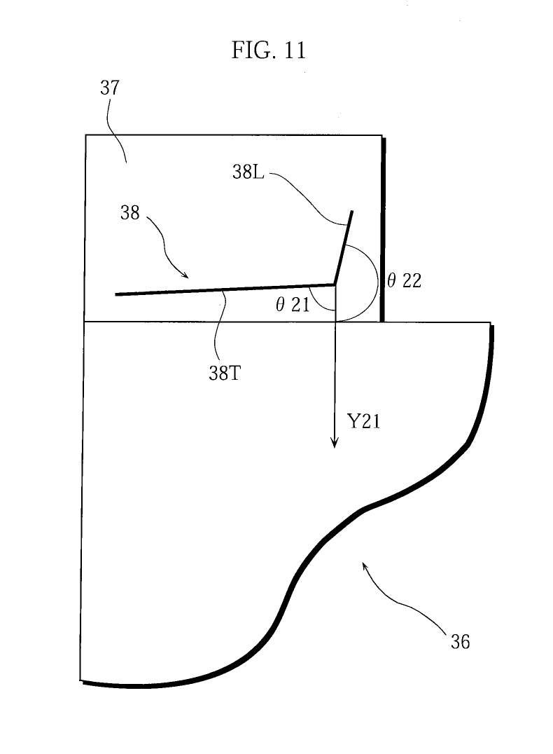

(1) In the battery A of the invention, the incision 35 is formed in an L-shape so as to have a transverse portion 35T extending linearly from one side edge adjacent region to the other side edge adjacent region of the lead 11 in a direction crossing the current resulting from an internal short circuit at the right angle (i.e., the width L3 direction) and a longitudinal portion 35L extending linearly from the one end E2 of the transverse portion 35T in the opposite direction to the current direction Y1 at the time of an internal short circuit (in a vertically upward direction in FIG. 3). However, the directions in which the transverse portion and the longitudinal portion extend are not limited to the foregoing directions. Specifically, for example, as shown in FIG. 11, in the case of an L-shaped incision 38 formed in the positive electrode lead 37 of the positive electrode plate 36, it is sufficient that an angle θ21 formed by a transverse portion 38T with respect to the current direction Y21 at the time of an internal short circuit be about 45° to about 90°, more desirably about 70° to about 90°. Also, when the current direction Y21 is taken as 0°, it is sufficient that an angle θ22 formed by a longitudinal portion 38L and the current direction Y21 be about ±160° to about ±180°, more desirably about ±170° to about ±180°.

The shape of the incision may be other shapes than the above-described L-shape. For example, the incision may be formed in a hook shape comprising a curved line, such as the incision M14 of the foregoing test piece F15. It is possible to employ any shape other than the hook shape, as long as a plurality of current paths are formed in the lead and the current densities in the current paths are made non-uniform by providing the incision.

(2) In the battery A of the invention, the incision 35 is formed only in each of the positive electrode leads 11, but the incision may be formed only in each of the negative electrode leads or in both of each of the positive electrode leads and each of the negative electrode leads. However, when there is a difference in the degree of how easy the lead melts between the positive electrode lead and the negative electrode lead because of the differences in material and thickness, it is preferable that the incision be provided only in the lead that melts more easily.

(3) The battery A of the invention is a stack type battery in which a plurality (50 sheets) of the positive electrode plate 1 and a plurality (51 sheets) of the negative electrode plate 2 are connected in parallel in the battery. In the stack type battery, a sneak current occurs when a short circuit occurs at any one location between the positive electrode plates 1 and the negative electrode plates 2, as described previously referring to the schematic circuit diagram of FIG. 8. For this reason, the formation of the incision 35 in the positive electrode lead 11 ensures the safety of the battery effectively. On the other hand, in the case of the spirally-wound type battery, in which a spirally-wound electrode assembly is enclosed in a closed-end cylindrical battery case, for example, the sneak current does not occur because it does not have the configuration in which positive electrodes and the negative electrodes are connected in parallel in the battery. However, even with the battery that does not have the configuration in which positive electrodes and the negative electrodes are connected in parallel in the battery, the battery may be used to construct a battery module in which a plurality of such batteries are connected in parallel. In that case, when a short circuit occurs in any of the unit cells (single batteries) in the battery module, a sneak current can occur from the other unit cells (single batteries). In view of this, an incision may be formed in at least one location in any of the positive and negative electrode current collector leads, the positive and negative electrode current collector terminals, and the like of the unit cells (single batteries) of the battery module, and conductors and the like for connecting the unit cells (single batteries) to each other, in other words, in at least one conductor of a conductor electrically connecting positive electrodes to each other and a conductor electrically connecting negative electrode to each other so that current can be branched into a plurality of paths by the incision and that the maximum current density of any of the plurality of paths is equal to or greater than 1.5 times the maximum current density of any other of the paths. In this way, it is possible to construct a mechanism with a simple configuration that can effectively cut off the current when a sneak current occurs due to a short circuit without increasing the resistance, as in the case of one stack type battery.

In the case of the battery module, the incision may be formed in a conductor in the same manner as in the case of the foregoing stack type battery. In that case, it is possible, for example, that a thin layer portion made of a metal foil such as an aluminum foil be formed in an appropriate location in the conductor and the incision be formed in this thin layer portion.

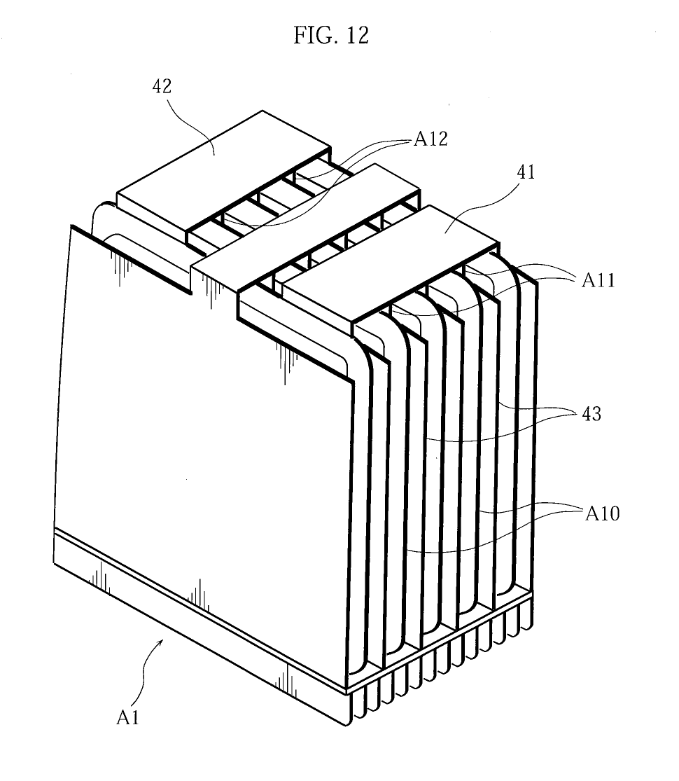

FIG. 12 is a perspective view illustrating one example of a battery module. A battery module A1 shown in the figure has a configuration in which a plurality (five) of the stack type batteries A10, each serving as a unit cell (single battery), are connected in parallel. Positive electrode current collector terminals A11 of the plurality (five) of the stack type batteries A10 are electrically connected to each other by a positive electrode conductor 41, and negative electrode current collector terminals A12 are electrically connected to each other by a negative electrode conductor 42. Reference numeral 43 in the figure denotes spacers interposed between the stack type batteries A10.

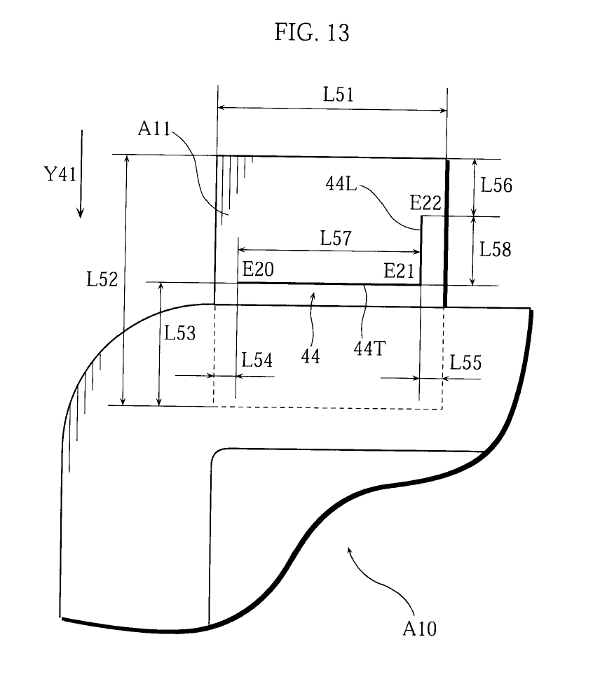

Each of the positive electrode current collector terminals A11 has an incision 44 formed therein. As illustrated in FIG. 13, the incision 44 is formed in a rectangular shape having a width L51=30 mm, a length L52=40 mm, and a thickness 0.5 mm in the positive electrode current collector terminal A11 made of an aluminum plate in a quadrilateral (rectangular) shape. The incision 44 is in an L-shape (a shape obtained by rotating the letter “L” 90° anticlockwise in FIG. 13) so as to connect three positions E20, E21, and E22. The position E20 is located at a distance L53=20 mm from the side edge of the positive electrode current collector terminal All near the stack type battery A10 and at a distance L54=5 mm from the outer side edge of the positive electrode current collector terminal A11 (the side edge near one side edge of the stack type battery A10 extending in its height direction, the left side edge in FIG. 13). The position E21 is located at a distance L53=20 mm from the side edge of the positive electrode current collector terminal A11 near the stack type battery A10 and at a distance L55=5 mm from the inner side edge of the positive electrode current collector terminal A11 (the right side edge in FIG. 13). The position E22 is located at a distance L56=12 mm from the side edge of the positive electrode current collector terminal A11 that is the farmost from the stack type battery A10 (the upper side edge in FIG. 13) and at a distance L55=5 mm from the inner edge of the positive electrode current collector terminal A11 (the right side edge in FIG. 13). In the incision 44, a transverse portion 44T, which extends from the position E20 to the position E21, has a length L57 of 20 mm, and a longitudinal portion 44L, which extends from the position E21 to the position E22, has a length L58 of 8 mm. The arrow Y41 in FIG. 13 indicates the direction in which the current flows when an internal short circuit occurs (in a downward direction in FIG. 13).

The configuration of the battery module in which the incision is formed in the above-described manner is particularly useful to ensure the safety of the battery module using as its unit cell (single battery) a battery that does not have the configuration in which positive electrodes and negative electrodes are connected in parallel in the battery, such as a spirally-wound type battery. However, it is also possible to form the incision in a like manner also in the case of the battery module using as its unit cell (single battery) the stack type battery in which positive electrodes and negative electrodes are connected in parallel in the battery. In such a battery module, when the incision is formed in at least one of the positive electrode current collector terminal and the negative electrode current collector terminal (such an incision is hereinafter also referred to as a “current collector terminal incision”) and the incision is not formed in at least one of the positive electrode leads and the negative electrode leads in each unit cell (single battery) (such an incision is hereinafter also referred to as a “lead incision”), it is possible to provide only one incision per each one of the unit cells (single batteries). In this case, the process work can be significantly less. However, if an internal short circuit occurs, the entire unit cell (single battery) that has caused the short circuit loses its function by being insulated because its current collector terminal melts down. On the other hand, in the case that only the lead incisions are formed, only the electrode plate that has caused the internal short circuit is insulated because its lead melts, and the other electrode plates do not lose their functions as the power-generating element so that the unit cell (single battery) as a whole can keep its function. Nevertheless, when both the lead incision and the current collector terminal incision are provided, a more reliable configuration can be achieved since the incisions are formed doubly.

(4) The positive electrode active material is not limited to the LiCoO₂, but may be other substances, such as LiNiO₂, LiMn₂O₄, and combinations thereof. Examples of the negative electrode active material that can be used suitably include natural graphite and artificial graphite.

(5) In the foregoing example, the negative electrode active material layer was formed on both sides of the negative electrode current collector for all the negative electrode plates 2. However, the negative electrode active material layers in the portions that do not face the positive electrode plates (specifically, the negative electrode active material layers on the outer sides of the outermost negative electrode plates) may be eliminated. Such a configuration allows the stacked electrode assembly to have a smaller thickness, allowing the battery to have a higher capacity density.

The present invention may be applied suitably to, for example, batteries used for such equipment as robots, electric vehicles, and backup power sources.

While detailed embodiments have been used to illustrate the present invention, to those skilled in the art, however, it will be apparent from the foregoing disclosure that various changes and modifications can be made therein without departing from the spirit and scope of the invention. Furthermore, the foregoing description of the embodiments according to the present invention is provided for illustration only, and is not intended to limit the invention.

What is claimed is:

1. A stack type battery comprising:
a plurality of positive electrode plates; a plurality of negative electrode plates; a plurality of separators interposed between the positive and negative electrode plates alternately stacked on each other; a positive electrode current collector terminal; a negative electrode current collector terminal, a plurality of positive electrode leads extending outward from the respective positive electrode plates, the positive electrode leads being stacked on each other and joined to the positive electrode current collector terminal; and a plurality of negative electrode leads extending outward from the respective negative electrode plates, the negative electrode leads being stacked on each other and joined to the negative electrode current collector terminal, wherein
at least one of the positive electrode lead and the negative electrode lead has an incision formed therein so that a current passing through the lead is branched into a plurality of paths by the incision and that the maximum current density of any of the plurality of paths is equal to or greater than 1.5 times the maximum current density of any other of the plurality of the paths.

2. The stack type battery according to claim 1, wherein the incision is formed in a substantially hook shape, the incision having a transverse portion extending from one side edge adjacent region of the lead to the other side edge adjacent region in a direction crossing a current flowing through the lead when an internal short circuit occurs, and a longitudinal portion extending from one end of the transverse portion in substantially the opposite direction to the direction in which the current flows when the internal short circuit occurs.

3. The stack type battery according to claim 2, wherein the transverse portion and the longitudinal portion of the incision extend linearly so that the incision is in a substantially L-shape.

4. The stack type battery according to claim 2, wherein a crossing corner portion of the transverse portion and the longitudinal portion of the incision is formed in a curved shape.

5. A battery module comprising:
a plurality of batteries connected in parallel, wherein
at least one of a conductor connecting positive electrodes to each other and a conductor connecting negative electrodes to each other between the batteries has an incision formed therein so that a current passing through the conductor is branched into a plurality of paths by the incision and that the maximum current density of any of the plurality of paths is equal to or greater than 1.5 times the maximum current density of any other of the plurality of the paths.

6. The battery module according to claim 5, wherein the incision is formed in a substantially hook shape, the incision having a transverse portion extending from one side edge adjacent region of the conductor to the other side edge adjacent region in a direction crossing a current flowing through the conductor when an internal short circuit occurs, and a longitudinal portion extending from one end of the transverse portion in substantially the opposite direction to the direction in which the current flows when the internal short circuit occurs.

7. The battery module according to claim 6, wherein the transverse portion and the longitudinal portion of the incision extend linearly so that the incision is in a substantially L-shape.

8. The battery module according to claim 6, wherein a crossing corner portion of the transverse portion and the longitudinal portion of the incision is formed in a curved shape.
